(19) United States
(12) Patent Application Publication
(10) Pub. No.: US 2018/0149556 A1
(43) Pub. Date: May 31, 2018

(54) OPTICAL FIBER TEST APPARATUS

(71) Applicant: AFL TELECOMMUNICATIONS LLC, Duncan, SC (US)

(72) Inventors: Seán Patrick Adam, Wrentham, MA (US); Dale Chan ning Eddy, Gilford, NH (US); Scott Prescott, Belmont, NH (US)

(21) Appl. No.: 15/575,194

(22) PCT Filed: Jun. 7, 2016
(86) PCT No.: PCT/US16/36186

§ 371 Date: Nov. 17, 2017

Related U.S. Application Data
(60) Provisional application No. 62/173,072, filed on Jun. 9, 2015.

(51) Int. Cl. G01M 11/00

(52) U.S. Cl. CPC G01M 11/30

(57) ABSTRACT

An optical fiber test apparatus includes an optical power meter operable to detect light at a predetermined wavelength, and a laser source operable to generate a visible laser beam. The optical fiber test apparatus further includes an optical connector comprising a test port, and an optical fiber extending between a first end and a second end and coupled at the second end to the optical connector. The optical fiber test apparatus further includes a coupling device, the coupling device coupled to the optical power meter, the laser source, and the first end of the optical fiber. The coupling device is operable to transmit light at the predetermined wavelength from the optical connector to the optical power meter and transmit the visible laser beam from the laser source to the optical connector.

### PRIORITY STATEMENT

The present application claims priority to U.S. Provisional Patent Application Ser. No. 62/173,072, filed Jun. 9, 2015 and which is incorporated by reference herein in its entirety.

### FIELD OF THE INVENTION

The present disclosure relates generally to optical fiber test apparatus, and more particularly to improved test apparatus which provide features for both measuring light transmission through optical fibers and detecting fault locations on the optical fibers.

### BACKGROUND OF THE INVENTION

At present it requires three separate instruments to test and troubleshoot a failed/failing fiber span to determine where the problem may lie. The first two instruments are an optical power meter (OPM) and a matching optical light source, ‘matching’ defined as the light source operating on wavelengths the OPM is designed to detect and measure. The third instrument is a visual fault indicator (VFI) embodied as a visible light source, typically a laser emitting in the visible spectrum. If a fiber span fails the loss test, one of the two testing instruments must be removed and replaced with the visual fault indicator in order to locate the fault causing the loss test failure.

The use of these separate test instruments is time consuming, cumbersome, and can result in damage to the optical connector on the fiber span under test and/or the test port optical connector.

Accordingly, improved testing apparatus for optical fibers is desired. In particular, testing apparatus that reduce or eliminate the requirement for multiple separate instruments, and that thus reduce the associated time and risk involved in such testing, would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, an optical fiber test apparatus is provided. The optical fiber test apparatus includes an optical power meter operable to detect light at a predetermined wavelength, and a laser source operable to generate a visible laser beam. The optical fiber test apparatus further includes an optical connector comprising a test port, and an optical fiber extending between a first end and a second end and coupled at the second end to the optical connector. The optical fiber test apparatus further includes a coupling device, the coupling device coupled to the optical power meter, the laser source, and the first end of the optical fiber. The coupling device is operable to transmit light at the predetermined wavelength from the optical connector to the optical power meter and transmit the visible laser beam from the laser source to the optical connector.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an optical fiber test apparatus in accordance with one embodiment of the present disclosure;

FIG. 2 illustrates an optical fiber test apparatus in accordance with another embodiment of the present disclosure; and

FIG. 3 illustrates an optical fiber test apparatus in accordance with another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to optical fiber test apparatus which advantageously provide features for both measuring light transmission through optical fibers and detecting fault locations on the optical fibers. Test apparatus in accordance with the present disclosure include both optical power meters and laser sources, and provide novel features for simultaneously connecting an optical power meter and laser source to a optical fiber to be tested. Accordingly, testing of optical fibers utilizing test apparatus in accordance with the present disclosure will advantageously be more efficient and will reduce the risks associated with the use of separate test instruments for various testing requirements. For example, troubleshooting a failed fiber span will be made less time consuming. Test apparatus in accordance with the present disclosure advantageously eliminate the need for a separate visible light source, and eliminates the requirement to disconnect the optical power meter in order to connect a visible light source, in turn reducing the probability of damaging the optical connector on the fiber span under test and/or the test port optical connector by eliminating an optical connector/test port disconnect/connect cycle.

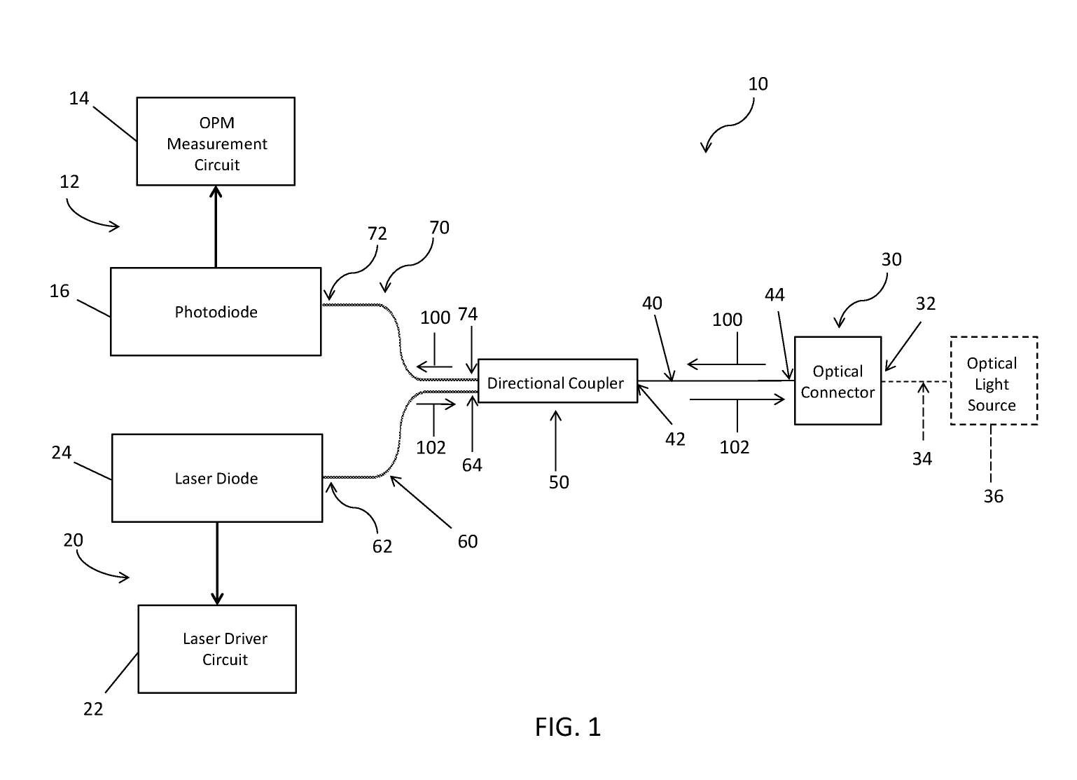

Referring now to FIGS. 1 through 3, various embodiments of an optical fiber test apparatus 10 in accordance with the present disclosure are illustrated. A test apparatus 10 may include, for example, an optical power meter 12. The optical power meter 12 is generally operable to detect and measure the power of light at one or more predetermined wavelengths or ranges of wavelengths. The detected and measured light is, in exemplary embodiments, light on the infrared wavelength spectrum. Common wavelengths (i.e. those utilized in optical fibers) include 850 nanometers, 1300 nanometers, and 1550 nanometers. In general, an optical power meter 12 may include a measurement circuit 14. The measurement circuit 14 may generally convert a received signal for measurement and/or display purposes. For example, the measurement circuit 14 may convert a received current into a voltage, and send this voltage to an analog to digital converter. The resulting digital signal may then be displayed as an optical power meter 12 output.

The received current may be converted from received light at a particular wavelength. For example, in exemplary embodiments, the optical power meter 12 may further include a photodiode 16 which generally converts received light into current. This current may then, for example, be received by the measurement circuit 14. Alternatively, a photodiode 16 may be included in the apparatus 10 but in another component, such as in a tap photodetector (discussed herein) separate from the optical power meter 12.

Test apparatus 10 may further include a laser source 20. The laser source 20 may be operable to generate a visible laser beam, i.e. a laser beam within the visible wavelength spectrum (390 nanometers to 700 nanometers, such as in some embodiments 525 nanometers to 700 nanometers). In exemplary embodiments, the laser beam may, for example, be green or red. Laser source 20 may, for example, include a laser driver circuit 22. Laser source 20 may further include a laser diode 24. The laser driver circuit 22 may generally drive the laser diode 24 to produce a laser beam at a desired wavelength, i.e. a visible wavelength.

The test apparatus 10 may further include an optical connector 30 which may include a test port 32. The test port 32 may be a port of the optical connector 30 to which an optical fiber 34 to be tested may be connected to the optical connector 30. The optical connector 30 may in exemplary embodiments be a universal connector interface or an FC connector (i.e. ferrule connector or fiber channel connector). Suitable FC connectors may include, for example, FC/UPC and FC/APC connectors. Alternatively, however, other suitable optical connectors 30 may be utilized.

Notably, the optical fiber 34 to be tested may be a single mode or multi-mode optical fiber. An optical light source 36 may generate light (i.e. infrared light) at a suitable predetermined wavelength(s) for transmission through the optical fiber 34 to the test apparatus 10 through the optical connector 30 thereof, and through the test apparatus 10 to the optical power meter 12 thereof for detection and measurement.

The test apparatus 10 may further include a first optical fiber 40 which extends between a first end 42 and a second end 44. The optical fiber 40 may be a single mode or multi-mode optical fiber. The optical fiber 40 may be coupled (such as directly coupled) at the second end 44 thereof to the optical connector 30. The optical fiber 40 may provide for the transmission therethrough of light to and from the optical connector 30, and thus to and from the optical fiber 34 being tested. For example, light (i.e. infrared light) at a suitable predetermined wavelength(s) generated by optical light source 36 may be transmitted (i.e. in direction 100) from optical connector 30 to and through optical fiber 40 for transmission to the optical power meter 12. Additionally, visible laser beams may be transmitted from the laser source 20 to and through the optical fiber 40 (i.e. in direction 102), and from the optical fiber 40 through the optical connector 30 to the optical fiber 34 for, for example, fault detection purposes.

Test apparatus 10 may further include a coupling device 50. The coupling device 50 may allow the transmission of light therethrough, and may direct light (i.e. infrared light) at a suitable predetermined wavelength(s) generated by optical light source 36 to the optical power meter 12 and visible laser light from laser source 20 to the optical connector 30 for transmission therethrough to the optical fiber 34. Coupling device 50 may thus be coupled (i.e. directly coupled) to the optical fiber 40 at the first end 42 thereof.

For example, in some embodiments as illustrated in FIG. 1, the coupling device 50 may be a directional coupler. Suitable directional couplers include, for example, coupled line directional couplers (such as hybrid couplers) and wavelength-division multiplexer (which may be filtered). In these embodiments, optical fibers may couple the coupling device 50 to the optical power meter 12 and the laser source 20.

For example, as shown, the test apparatus 10 may further include a second optical fiber 60 which extends between a first end 62 and a second end 64. The optical fiber 60 may be a single mode or multi-mode optical fiber. The optical fiber 60 may be coupled (such as directly coupled) at the first end 62 to the laser source 20 (i.e. to the laser diode 24 thereof) and at the second end 64 to the coupling device 50. Accordingly, visible laser beams generated by the laser source 20 may be transmitted through the second optical fiber 60 to the coupling device 50 and from the coupling device through the first optical fiber 40 to the optical connector 30 (and thus to the optical fiber 34).

Further, the test apparatus 10 may further include a third optical fiber 70 which extends between a first end 72 and a second end 74. The optical fiber 70 may be a single mode or multi-mode optical fiber. The optical fiber 70 may be coupled (such as directly coupled) at the first end 72 to the optical power meter 12 (i.e. to the photodiode 16 thereof such that the photodiode 16 couples the optical fiber 70 to the optical power meter 12) and at the second end 64 to the coupling device 50. Accordingly, light (i.e. infrared light) at a suitable predetermined wavelength(s) generated by optical light source 36 may be transmitted from the coupling device 50 through the third optical fiber 70 to the optical power meter 12.

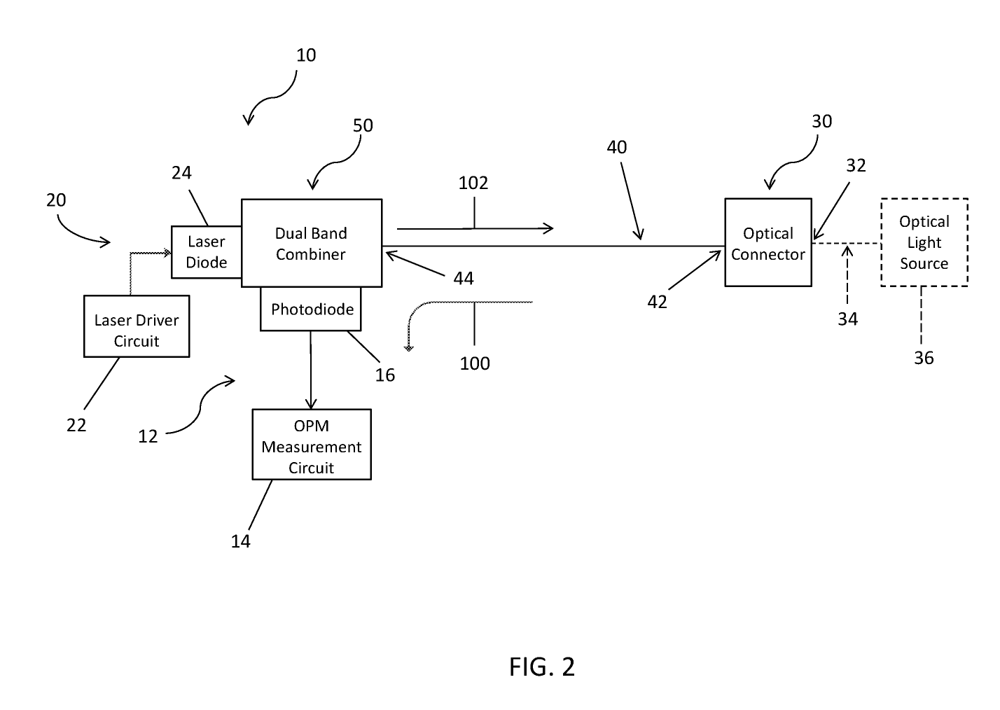

In other embodiments as illustrated in FIG. 2, the coupling device 50 may be a dual band combiner. The combiner may, for example, include a beam splitter or dichroic mirror. In these embodiments, the laser diode 24 and photodiode 16 may be connected, such as directly connected to the coupling device 50. Accordingly, visible laser beams generated by the laser source 20 may be transmitted to the coupling device 50 and from the coupling device through the first optical fiber 40 to the optical connector 30 (and thus to the optical fiber 34). Light (i.e. infrared light) at a suitable predetermined wavelength(s) generated by optical light source 36 may be transmitted from the coupling device 50 to the optical power meter 12.

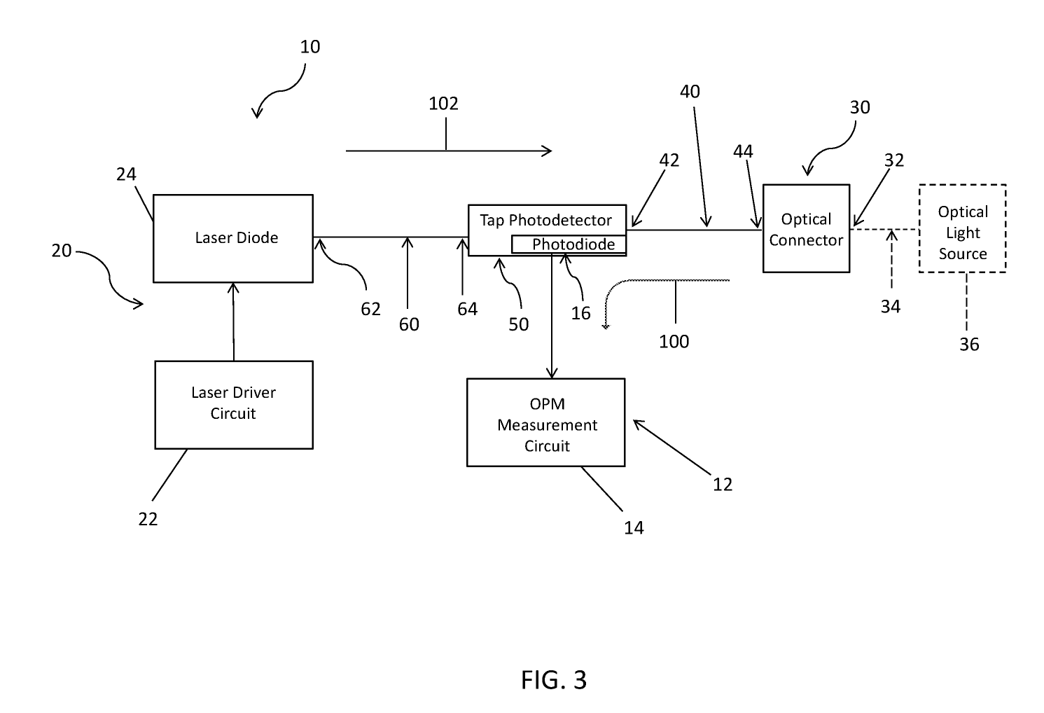

In still other embodiments, as illustrated in FIG. 3, the coupling device 50 may be a unidirectional tap photodetector. The unidirectional tap photodetector may include a suitable tap, and may further include the photodiode 16 (which may couple the optical power meter 12 to the coupling device 50). In these embodiments, an optical fiber may couple the coupling device 50 to the laser source 20.

For example, as shown, the test apparatus 10 may further include a second optical fiber 60 which extends between a first end 62 and a second end 64. The optical fiber 60 may be a single mode or multi-mode optical fiber. The optical fiber 60 may be coupled (such as directly coupled) at the first end 62 to the laser source 20 (i.e. to the laser diode 24 thereof) and at the second end 64 to the coupling device 50. Accordingly, visible laser beams generated by the laser source 20 may be transmitted through the second optical fiber 60 to the coupling device 50 and from the coupling device through the first optical fiber 40 to the optical connector 30 (and thus to the optical fiber 34).

As discussed, in embodiments wherein the coupling device 50 is a unidirectional tap photodetector, the coupling device 50 may include the photodiode 16. The photodiode 16 may couple the optical power meter 12 to the coupling device 50. Accordingly, light (i.e. infrared light) at a suitable predetermined wavelength(s) generated by optical light source 36 may be transmitted from the coupling device 50 through the photodiode 16 to the optical power meter 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An optical fiber test apparatus, comprising:
an optical power meter operable to detect light at a predetermined wavelength;
a laser source operable to generate a visible laser beam;
an optical connector comprising a test port;
an optical fiber extending between a first end and a second end and coupled at the second end to the optical connector; and
a coupling device, the coupling device coupled to the optical power meter, the laser source, and the first end of the optical fiber, the coupling device operable to transmit light at the predetermined wavelength from the optical connector to the optical power meter and transmit the visible laser beam from the laser source to the optical connector.

2. The optical fiber test apparatus of claim 1, wherein the coupling device is a directional coupler.

3. The optical fiber test apparatus of claim 2, wherein the directional coupler is a wavelength-division multiplexer.

4. The optical fiber test apparatus of claim 2, wherein the optical fiber is a first optical fiber, and further comprising a second optical fiber and a third optical fiber, the second optical fiber extending between a first end coupled to the laser source and a second end coupled to the coupling device, the third optical fiber extending between a first end coupled to the optical power meter and a second end coupled to the coupling device.

5. The optical fiber test apparatus of claim 4, further comprising a photodiode, the photodiode coupling the third optical fiber to the optical power meter.

6. The optical fiber test apparatus of claim 1, wherein the coupling device is a dual band combiner.

7. The optical fiber test apparatus of claim 1, wherein the coupling device is a unidirectional tap photodetector.

8. The optical fiber test apparatus of claim 7, wherein the optical fiber is a first optical fiber, and further comprising a second optical fiber, the second optical fiber extending between a first end coupled to the laser source and a second end coupled to the coupling device,

9. The optical fiber test apparatus of claim 1, further comprising a photodiode, the photodiode coupling the optical power meter to the coupling device.

10. The optical fiber test apparatus of claim 1, wherein the optical fiber is a multi-mode optical fiber.

11. The optical fiber test apparatus of claim 1, wherein the optical fiber is a single mode optical fiber.

12. The optical fiber test apparatus of claim 1, wherein the optical connector is a universal connector interface.

13. The optical fiber test apparatus of claim 1, wherein the optical connector is an FC connector.

14. The optical fiber test apparatus of claim 1, wherein the laser source comprises a laser driver circuit and a laser diode.

15. An optical fiber test apparatus, comprising:
an optical power meter operable to detect light at a predetermined wavelength;
a photodiode;
a laser source operable to generate a visible laser beam, the laser source comprising a laser driver circuit and a laser diode;
an optical connector comprising a test port;
an optical fiber extending between a first end and a second end and coupled at the second end to the optical connector; and
a coupling device, the coupling device coupled through the photodiode to the optical power meter, coupled to the laser source, and coupled to the first end of the optical fiber, the coupling device operable to transmit light at the predetermined wavelength from the optical connector to the optical power meter and transmit the visible laser beam from the laser source to the optical connector.

16. The optical fiber test apparatus of claim 15, wherein the coupling device is a directional coupler.

17. The optical fiber test apparatus of claim 16, wherein the optical fiber is a first optical fiber, and further comprising a second optical fiber and a third optical fiber, the second optical fiber extending between a first end coupled to the laser source and a second end coupled to the coupling device, the third optical fiber extending between a first end coupled to the optical power meter and a second end coupled to the coupling device.

18. The optical fiber test apparatus of claim 15, wherein the coupling device is a dual band combiner.

19. The optical fiber test apparatus of claim 15, wherein the coupling device is a unidirectional tap photodetector.

20. The optical fiber test apparatus of claim 19, wherein the optical fiber is a first optical fiber, and further comprising a second optical fiber, the second optical fiber extending between a first end coupled to the laser source and a second end coupled to the coupling device,
